(19) United States
(12) Patent Application Publication
(10) Pub. No.: US 2006/0191637 A1
(43) Pub. Date: Aug. 31, 2006

(54) Etching Apparatus and Process with Thickness and Uniformity Control

(76) Inventors: John Zajac, San Jose, CA (US); Stephen Edward Savas, Chungli (TW)

Correspondence Address: EDWARD S. WRIGHT, 1100 ALMA STREET, SUITE 207, MENLO PARK, CA, 94025, US

(21) Appl. No.: 11/383,382

(22) Filed: May 15, 2006

Related U.S. Application Data
(62) Division of application No. 09/886,580, filed on Jun. 21, 2001.

(51) Int. Cl. C03C 25/68; C23F 1/00

(52) U.S. Cl. 156/345.34; 216/58

(57) ABSTRACT

Apparatus and process for etching semiconductor wafers and the like in which a substrate is supported by a pedestal within a chamber, and at least one gas capable of etching the substrate or a film material on the substrate is introduced into the chamber through a segmented gas injection element which is separated from the substrate by a distance approximately less than its size from which the distribution of the flow or mixture of gas can be altered spatially proximate to the substrate in a controlled and variable way, for each wafer or substrate if desired, by having a varying amount or mixture of gas flow to some or all of the segments such as to cause the etching rate distribution to vary across the substrate.

### CROSS REFERENCE TO RELATED APPLICATIONS

This is a division of Ser. No. 09/886,580, filed Jun. 21, 2001.

### BACKGROUND OF THE INVENTION

1. Field of Invention

This invention pertains generally to the processing of silicon wafers, other substrates, or other flat workpieces used in semiconductor, Micro-Electro-Mechanical Systems (MEMS), magnetoelectronic or flat panel display manufacturing and, more particularly, to the etching of, or deposition on such wafers, substrates or other workpieces. It provides an apparatus and method for rapidly changing in an automatic, controlled manner the spatial distribution of etching the workpiece or a film thereupon, or changing properties such as thickness or material properties of a film deposited across that substrate or workpiece.

2. Related Art

One particular use of this invention may be as a part of the sequence of manufacturing steps for producing monocrystalline silicon wafers for semiconductor integrated circuits. As such integrated circuits decrease in size and improve in performance higher quality silicon wafers will be required. Furthermore, soon the wafer size for some new factories will be increasing to 300 mm which makes further demands on wafer quality for the sake of photolithographic process performance. Such wafers will have to be very uniform in thickness and be free of damage such as microscopic scratches and crystal dislocations caused by the mechanical grinding processes that are in common use. Yet, such wafers need to be low in cost so as to reduce integrated circuit cost.

In the current production method for wafers slices are cut from an ingot of silicon which are ground or lapped to a thickness slightly greater than desired and an acceptable level of thickness non-uniformity. These slices then have their damaged silicon removed, by lapping, polishing or by a wet etching process, and are further polished to acceptable smoothness which reduces the wafer to its final desired thickness.

For production wafers to meet the more exacting site flatness specification required in the future using lapping and polishing process is inefficient and slow. This is expensive since the lapping and polishing process is not well suited to controlled non-uniform removal rates.

Alternative and less expensive methods of removing excess, or damaged, silicon, and especially such that the non-uniformity of silicon thickness are greatly reduced, would be very desirable as a way of reducing cost and improving productivity. Wet chemical removal of the silicon is possible but is currently unsuitable for removing silicon in a controlled non-uniform manner so as to yield wafers of uniform thickness. Further, the cost, safety, and environmental concerns, limit the usefulness of this approach.

An alternative approach might be to use plasma etching or Reactive Ion Etching (RIE). However, typical plasma etch processes used for integrated circuit manufacturing are typically too slow to be used for efficiently etching several of microns of silicon. Further, these processes usually utilize energetic ion impact to promote etching and such ion bombardment at energies at or above 50 eV can cause crystalline defects in the silicon. These problems may be able to be overcome, but known RIE processes are basically uniform or have a fixed pattern of non-uniformity. Hence, the key issue of controlled non-uniformity remains unaddressed by any of the conventional etch processes.

Plasma etching (RIE) technology for semiconductor production has virtually always had as a requirement the uniform etching of the wafer or layers of material deposited on the wafer. However, for manufacturing uniform thickness silicon wafers for future smaller devices it will be necessary to remove more silicon from areas of the wafer which are initially thicker than from other areas in order to leave the wafer with thickness site flatness variations less than or about 0.1 micron. Plasma or reactive ion etching methods have never been shown to be capable of tailoring the non-uniformity of their etch rate for individual wafers so as to etch faster where they are thicker thus reducing their thickness variations. This method could be of commercial value if it could yield wafers uniform in thickness over the area of a site (a few cm in size) to about a tenth of a micron.

Such a non-uniform etching (or CVD) method and apparatus might also be useful in manufacturing Micro-Electro-Mechanical Systems. Commonly in such applications large amounts of silicon or other substrate material are often etched, and that material in some stage(s) of preparation may have non-uniform thickness or other properties which require non-uniform processing. It may also be appropriate for other processes such as deposition or etching of films on a substrate. Such etching or deposition may be useful to produce devices which have properties which vary with position across the wafer or substrate, such that a desired range of device properties are produced from a single substrate. In some applications it may be useful if deposition processes could be performed on a substrate where the properties of the deposited film other than the thickness would be non-uniform. Such variations in deposited film properties might compensate for variations in properties of other film layers on the wafer or variations in the substrate. It could also be used to cause the properties of the devices fabricated from such films to vary in a controlled manner across the substrate.

Other embodiments of this invention may be used for providing for varying film thickness(es) for some layers for flat panel devices or magnetoelectronic devices. Such varying film layers or feature thicknesses could be created by etching or deposition or a combination thereof to compensate for existing non-uniformities of layers so as to provide for device properties which could be uniform across the wafer or substrate. They could also be used for providing device properties which vary across the substrate. Such method and apparatus could further be used for manufacturing devices which occupy a large part of a substrate in which the thickness of the films, structures or substrate should vary across the substrate so as to produce desired varying device properties.

Reactors using a powered top or powered bottom electrode employing any RF band or bands of frequencies for excitation of the discharge have often been used for etching and plasma deposition on the silicon substrates for integrated circuit manufacturing. It has in virtually every case been one of the major requirements for such reactors that the etching or deposition rate be as uniform as possible. As such, efforts have almost exclusively been made to make the processing of such reactors more and more uniform, and never less uniform by design. Attempts to control (improve) uniformity in many cases were centered around altering the shape or physical dimensions of the top electrode or the gap between electrodes. Referenced are prior art patents in which different methods of compensating were found for inherent non-uniformity in parallel plate etching reactors.

FIG. 1 illustrates a section view of a standard parallel plate reactor where the top, bottom or both electrodes are powered and where the wafer to be etched or deposited upon is placed on the bottom electrode. The radio frequency powered upper electrode 101, the cathode, is also usually used as a showerhead for the introduction of gases into the plasma discharge. Within said electrode is a gas reservoir 102 for distribution of the gas to the holes in that areas of the structure which will inject gas into the region between the electrodes. The lower electrode 103 is sometimes grounded electrically and serves therefore as the anode of the discharge. The gas supply to the showerhead consists in the mass flow controller 104 which is connected by a line to the pressurized source of gas 105 which meters the supply of gas to the reservoir 102 which supplies gas to the plasma discharge through holes 106. The radio frequency power supply and impedance matching network 107 provides the power to the cathode. The wafer or substrate 108 is placed upon the flat surface of the lower electrode to be etched or deposited thereupon. The injected gases 109 are broken down by the plasma discharge and etching or deposition occurs on the wafer or substrate. A vacuum pump exhausts the gases, including reaction products from the chamber.

U.S. Pat. No. 4,342,901 discloses a system in which a sloping of the top electrode (where the gap between electrodes varies) compensates for the inherent faster etching in the center of a batch reactor where several wafers may be placed on the lower electrode.

U.S. Pat. No. 4,230,515 discloses a system in which the electrode facing the wafer is physically altered to vary the spatial distribution of the etch rate. This alteration has been used to compensate for the inherent slow etching of aluminum in the center of a wafer.

These etching systems could alter wafer processing uniformity in very limited ways—most were not capable of changing etch rate distribution with each wafer and those that could (see Lam) were not used in such manner. These systems were only used to alter the etching rate distribution to make it more uniform spatially across the wafer, and only in a single way, such as from the center to the edge of the wafer or from the center to the edge of the reactor. In fact, none was able even to adjust the edge to center uniformity in a manner that would give independent variation of regions near the center, near the edge and the area in between. None of the previous systems attempted to make the etching less uniform, nor did they attempt to adjust from wafer to wafer, nor were they capable of adjusting the etching rate in a non-symmetrical (center to edge) manner. Furthermore, none of them could have etch distribution adjusted according to an arbitrary desired non-uniform etching rate profile from one wafer to the next, nor were they able or used to adjust the etch non-uniformity during the etch process. These prior art etching chambers achieved their goal of improving what would otherwise have been problematic non-uniformities of up to plus or minus ten or more percent in the etching rates. None were intended to make the etching rate less uniform to compensate for non-uniformity of film or wafer thickness. None was able to respond to individual wafer properties such as thickness distribution by having the flexibly to adjust etch rate distribution across the wafer.

### OBJECTS AND SUMMARY OF THE INVENTION

It is in general an object of the invention to provide a new and improved system and method for plasma-based etching a silicon or other substrate, or film thereupon, or for depositing a film on a substrate.

Another object of the invention is to provide a system and method of the above character with an automatically variable distribution of etch or deposition rate, or other deposited film or process properties across the substrate.

These and other objects are achieved in accordance with the invention by causing the distribution of gas(es) provided to the volume of plasma adjacent to the substrate to vary spatially and in a controlled manner using a segmented gas injector structure. This structure, which may be one piece or more than one, injects gas into the region of plasma proximate to the substrate such that the concentrations of gas-phase species in the volume immediately adjacent to the substrate may vary with position on the substrate. Such gas distribution structure may be immersed in or bordering the volume adjacent to the substrate. In all embodiments the gas injection structure is within a reasonable distance of the substrate or wafer—that being roughly half the size of the wafer or substrate. One embodiment of such is to have the showerhead for a capacitive, parallel plate rf discharge be such a gas injection structure. The flows of any gas(es) provided for the process from the structure may have their distribution spatially varied across the region adjacent to the substrate by having different flows or compositions coming from different parts or segments of the structure. Such a gas injection structure may have different gas feed lines with separate valves or controllers providing gas(es) to the segments of the structure. It may also have a single or multiple injector line(s) with means for adjusting the relative flows of feed gas(es) to the different segments.

In one embodiment of the invention the system employs a plasma for activating the gas(es) injected into the volume adjacent to the substrate. By the action of the plasma the gas(es) are partially dissociated and ionized, becoming activated species which participate in the etching or deposition process on the exposed surface of the substrate. In this case the injector for the process gas(es) may take the form of a showerhead or grid or other partially transmissive (of some or all plasma species) structure immersed in the plasma. Alternatively, the structure could consist of separate injectors which feed gas(es) to different areas above the substrate. One embodiment would be a grid or array of thin tubes with holes to inject gas into the plasma. The gas(es) supplied to the structure may come from a plurality of gas feed lines which are themselves fed by gas flow controllers and flows to such feed lines may be capable of being turned on or off.

It is an alternative embodiment of this invention wherein the plasma generation is done by a capacitively coupled radio frequency discharge between substantially parallel planar electrodes. In this embodiment one electrode may be the substrate-holding pedestal while the other electrode may also serve as the gas injection structure or showerhead. In this case the showerhead may have a reservoir or supply system for the gas behind its surface which is adjacent to the plasma. This reservoir or supply system is capable of having controlled, variable flows of gas(es) to a plurality of its sections which in turn feed certain areas of injector holes of said showerhead. A given combination of gas flows to such sections then produces spatial distribution of the gas phase in the plasma adjacent to the substrate or wafer. When the spacing between the showerhead and the wafer holding pedestal is small compared with the size of such electrodes then the injected gas from any region of the showerhead participates most strongly in the processing of the adjacent region of the workpiece. Such distribution of gas may then be altered by changing the amounts or composition of such flows to different sections. The result of such multiple, controllable flows to said showerhead is that the composition of the plasma near some areas of the substrate may be varied with respect to that nearer to other areas. This, then produces the variability of the etching or deposition process across the surface of the substrate. The shape of such sections may be chosen to produce an etch or deposition pattern which is appropriate to the application or substrates. The process may use multiple steps in which substrates or wafers are successively processed in different plasma chambers or stations. The showerheads in those stations/chambers may be different in their segmentation pattern so that those etching or deposition steps taking place in the stations/chambers have different possible patterns of non-uniformity. Thus, the total process is a sum of the patterns from each of the stations weighted according to the time spent in each.

Such etching or deposition reactors typically employ a radio frequency (>10 kHz) electric discharge between two planar electrodes which are substantially parallel, with typical inter-electrode spacing somewhat less than the size of the electrodes. One electrode is typically a showerhead for injecting gas into the plasma. When used for processing many kinds of substrates including single semiconductor wafers, such electrodes may often have flat, substantially circular surfaces facing each other. In the case of etching processes for silicon-based materials the plasma of the discharge produces reactive species responsible for etching, usually including halogen atoms from a halogen containing gas. Etching of organic materials often uses an oxygen-based gas mixture. In some deposition applications the discharge produces molecular fragments containing silicon which will form part of a deposited layer. One distinguishing feature is that such showerhead be made to allow variability of the spatial distribution of halogenated or silicon containing or other reactive gas flow rate and/or gas composition injected into the plasma by it. The control system provided may be designed to be able to automatically control such gas distribution and or composition with sufficient speed to effect changes for individual wafers or some process step which is part of the etch or deposition of individual wafers.

It is the variation of such gas distribution that causes a controlled, spatially varying, concentration of etching or depositing species within the parallel plate discharge adjacent to which the substrate(s) is/are placed. It is this variation in the composition (and to a lesser extent pressure) of the gas that permits the controlled variation in the etch or deposition rate and thus uniformity control. This is because the reactive species containing gas from such showerhead is dissociated and partially ionized by the action of the electric discharge which takes place between the electrode/showerhead and the wafer holding electrode below. Thus, the spatial distribution of gas composition is reflected in alteration of the spatial distribution of the discharge characteristics and chemical (reactive species) composition. This is in turn reflected in the etch or deposition rate distribution or material properties of the deposited film on the wafer positioned on the facing electrode.

It is the ability to change the distribution of reactant gas flow and/or gas composition automatically, in accordance with the direction from a control system, quickly and without manual intervention, that permits automatic adjustments to produce a desired distribution of individual film properties or wafer etching rate. The ability to do this for each wafer in accordance with that wafer's non-uniformity in thickness or film thickness (as measured by thickness measurement means discussed above) or other properties permits this invention to make the wafer or film more uniform (or less uniform as desired) after the process than before. This invention is capable of performing such uniformity improvement for symmetrically or asymmetrically non-uniform wafers or films by symmetrical or non-symmetrical etching uniformity control. Such controlled distributed etching may also be exercised to compensate for the normal non-uniformity in the process rate of a system which might result when using uniform gas distribution.

In some embodiments of this invention this process is accomplished using measurements of substrate or film thickness to provide information used in controlling the etching or deposition rate. In this case, the etching or deposition process may reduce the non-uniformity of remaining film or thickness of the wafer, or in the case of deposition produce the desired thickness distribution or other film property. This may be done by intentionally creating a specific, non-uniform etch or deposition rate distribution to compensate for some types of preexisting non-uniformity in the film or wafer's thickness, and by etching or depositing with this process for an appropriate amount of time. This may in the case of etching reduce the overall wafer or film thickness non-uniformity to a much lower level. It may, in the case of deposition cause the deposited film to have some thickness distribution to compensate for some characteristic of the substrate or film on the substrate, or to produce a desired effect on the devices fabricated on the wafer. It is further an object of this invention to do such a process with sufficient control to avoid unintentionally causing significant non-uniformity of the wafer or film thickness. It is one embodiment to do measurements of the wafer or substrate or film thickness or desired properties between the steps so as to allow the control system to choose the best distribution for the following steps in the process

The process may be done on one single process station having some pattern of segmentation of the gas injection structure. It may also be done in a series of steps in a system having multiple processing stations, each possibly having a different gas distribution structure, wherein the workpiece is processed at a succession of these stations to produce the desired final distribution of the process result. The substrate may also be processed more than once at any station. When it is processed a second or later succeeding step at the same station or another station it may be rotated with respect to its original orientation.

An embodiment of the invention may include, and utilize for etching or deposition process control, means of measuring the thickness distribution of the film or substrate material for a processed or partially processed substrate. Such means for measuring film or substrate thickness may include one of many commercially available and sufficiently precise film or substrate thickness monitors. This method may be used to determine film or substrate thickness distribution initially, or when the etch or deposition process is partially completed. The resulting information may be used to adjust the etch or deposition process non-uniformity during the remainder of the process, either at that particular processing station or another. In general, information from such measurements may be used before or between some steps of the process to permit the control system to adjust gas flows to the injection structure of that station or another station. This multi-step procedure may then modify the total etching or deposition rate distribution on the substrate and thereby reduce, adjust or produce, as desired, specific non-uniformity in the thickness of that film or wafer.

A possible application may be one where the substrate thickness uniformity of a wafer is to be improved by adjustments in etch rate. Measurements of the film or substrate thickness may be made before any process step done at any processing station. In order to produce very fine control of the distribution of the etching rate the process may consist of several (or more) steps in which the wafer is etched successively in different stations or with different orientations in the same station(s). The control system would choose the duration of each step and the distribution of gases in the showerhead of each station for each step.

In an alternative embodiment the information gained at the end of an etch or deposition or end of a partial etch or deposition may be used to alter the process for subsequent wafers to compensate for drift or etch or deposition rate peculiarities. The measured data from such measurements of a priorwafer may be used in conjunction with measurements made before, or during the etching process to any specific wafer to alter the etching or deposition uniformity.

### BRIEF DESCRIPTION OF THE DRAWINGS

FIG. 1 is a sectional view, somewhat schematic, of a standard parallel plate reactor of the prior art.

FIG. 2 is a sectional view, somewhat schematic, of one embodiment of a reactor incorporating the invention.

FIGS. 3a and 3b are top plan views, somewhat schematic, illustrating possible arrangements of a segmented gas reservoir for the showerhead electrode in the embodiment of FIG. 2.

FIG. 4 is a sectional view, somewhat schematic, of another embodiment of a reactor incorporating the invention.

FIG. 5 is a sectional view, somewhat schematic, of another embodiment of a reactor incorporating the invention.

### DETAILED DESCRIPTION

Etching of or thin film deposition on a substrate with a desired non-uniform rate or film properties are achieved in this invention by providing independent control of gas mixtures and/or gas flow rates to different parts of the processing plasma volume above the substrate.

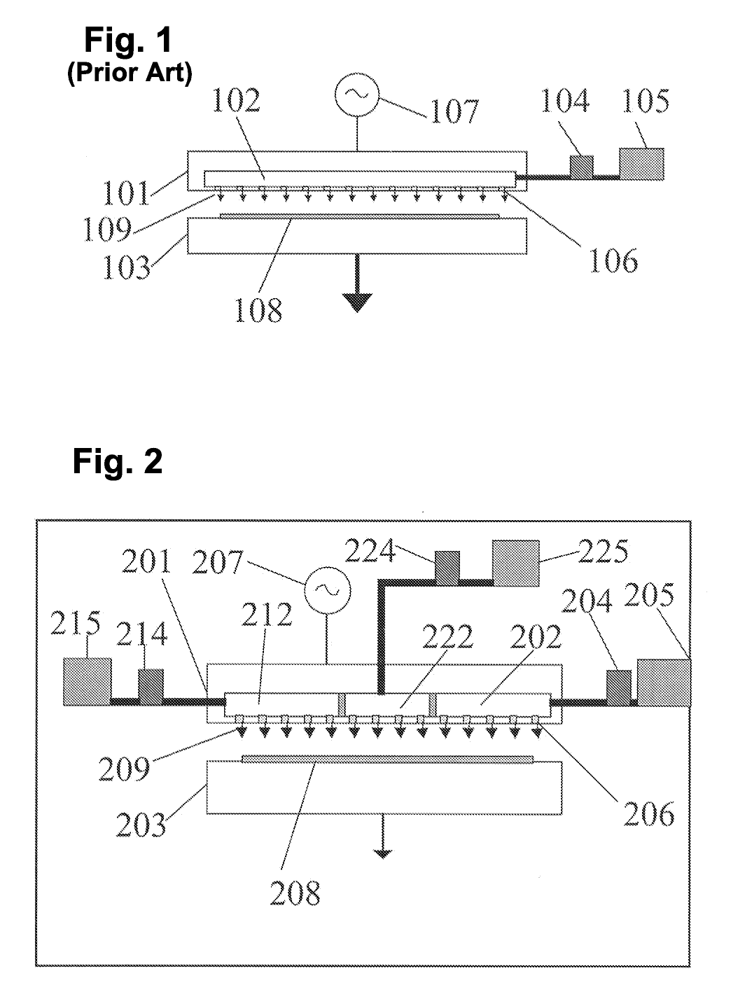

In one embodiment this may be accomplished using a showerhead (See FIG. 2) with a segmented gas reservoir. This figure illustrates a section view of a parallel plate embodiment of the reactor where the top, electrode is powered and where the wafer to be etched or deposited upon is placed on the bottom electrode. The radio frequency powered upper electrode 201, the cathode, is also used as a showerhead for the introduction of gases into the plasma discharge. Within said electrode are gas reservoirs 202, 212, 222 for distribution of the gas to the holes in certain areas of the structure. The lower electrode 203 is grounded electrically and serves therefore as the anode of the discharge. The gas supply to the showerhead comes through the mass flow controllers 204, 214 and 224 which are connected by lines to the pressurized source(s) of gas 205, 215, 225. These may be the same source under some embodiments. These flow controllers meter the supply of gas to the reservoirs 202, 212, and 222 which supplies gas to the different regions of the plasma discharge through holes 206. The radio frequency power supply and impedance matching network 207 provides the power to the cathode. The wafer or substrate 208 is placed upon the flat surface of the lower electrode to be etched or deposited thereupon. The injected gases 209 are broken down by the discharge powered by generator/impedance match network 207 and etching or deposition occurs on the wafer or substrate. Because the flows of gas may be different to different sections the rate of etching may be caused to vary from areas of the wafer adjacent to any section relative to the rate at areas adjacent to other sections. A vacuum pump exhausts the gases, including reaction products from the chamber.

The different segments of the reservoir 202, 212 and 222 in the showerhead 201 may also be supplied separately with two or more of the process gases from sources 205, 215, and 225. Each of these may represent more than one pressurized gas supply, such that the flows of the different gases to said segments may be individually controlled by sets of flow controllers 204,214 and 224 (each represents two or more controllers). Thereby after exiting the reservoir through holes 206 as a gas stream 209 the composition in that segment of the plasma, which may vary from section to section, is broken down due to power from generator/match network 207 adjacent to all parts of the wafer. At any location on the substrate 208 supported on pedestal/anode 203 corresponding roughly to the area of that segment of the showerhead, the etch or deposition rate being dependent on the flow rate and composition of the gas locally, may be altered by changing the flow of any of the feed gases to the segment. Etch or deposition rates in other areas of the wafer are likely also be affected by changing the flow(s) and composition to this segment of the showerhead due to the flow pattern of the gas which in some cases may be approximately outward from the center of flow from the showerhead. However, these changes are almost always smaller in magnitude than that in the most directly affected wafer area, which is adjacent to that segment of the showerhead. In controlling the flows to the different segments the effects on nearby segments of varying the flow to any segment should be taken into account.

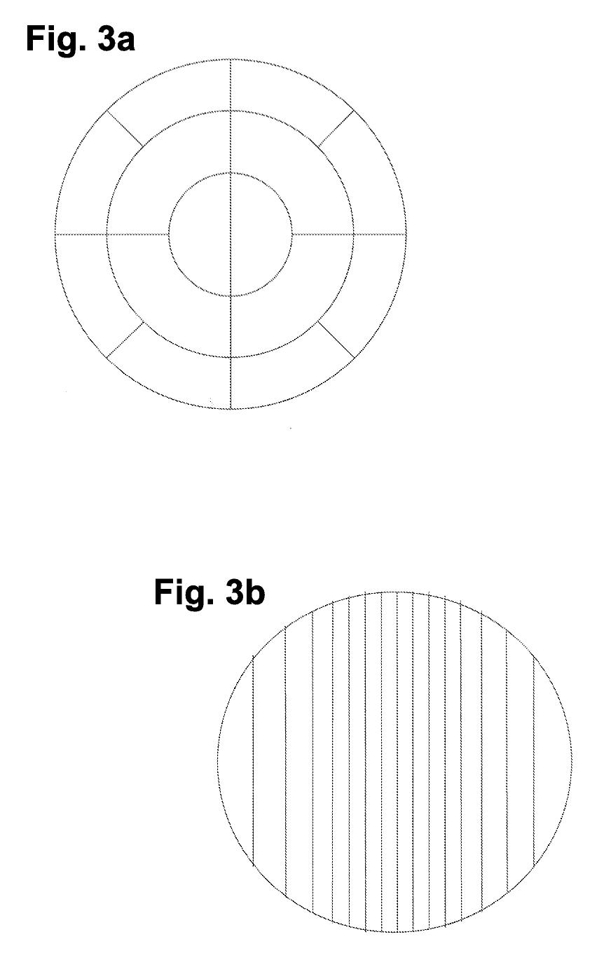

In one embodiment of this invention the control system takes into account the effect on etch or deposition rate over the entire wafer or substrate of the changing gas composition and/or flow to each segment. This may be done by a conventional computational algorithm or by a “neural net” type of computing algorithm or device. The pattern of gas flows to each and every segment of the gas reservoir in the showerhead will then be determined by this system such as to yield the desired distribution of etching or deposition rate across the wafer or other substrate. In many circumstances, the change to the rate of the process in the substrate area adjacent to that segment will be substantially greater than the change in the other area(s). Therefore the distribution of changes to reactant flows to the segments might be approximately proportional to the desired variation in process rate distribution. If a multi step process with very fine control of the distribution of the total amount etched or deposited is to be done, then the distribution of gases to each segment of each station needs to be determined. For each station this is likely to depend on the orientation of the substrate or wafer. The processing time at each station for any orientation of the substrate or wafer will be determined by the control system by an algorithm which uses the distribution of the process for that station and substrate or wafer orientation. The sum total of etching or deposition for all process steps should be as close as required to the desired distribution of removal or film deposition for that wafer or substrate. Possible patterns for the sections of the showerhead are shown in FIGS. 3a and 3b such sections should be roughly of equal area so as to simplify gas distribution.

Mass flow controllers, or any suitable flow control device, may be used to control the flow of one or more of the gases flowing to each of the sections. In one embodiment the total flows of a mixture containing the main etching or depositing gases may be controlled individually to each segment as shown in FIG. 2 to produce the spatially controlled process rate. In this case the total gas flow to the different segments may vary substantially in order to produce a large variation in etch rate from the wafer area adjacent to one segment to that next to another.

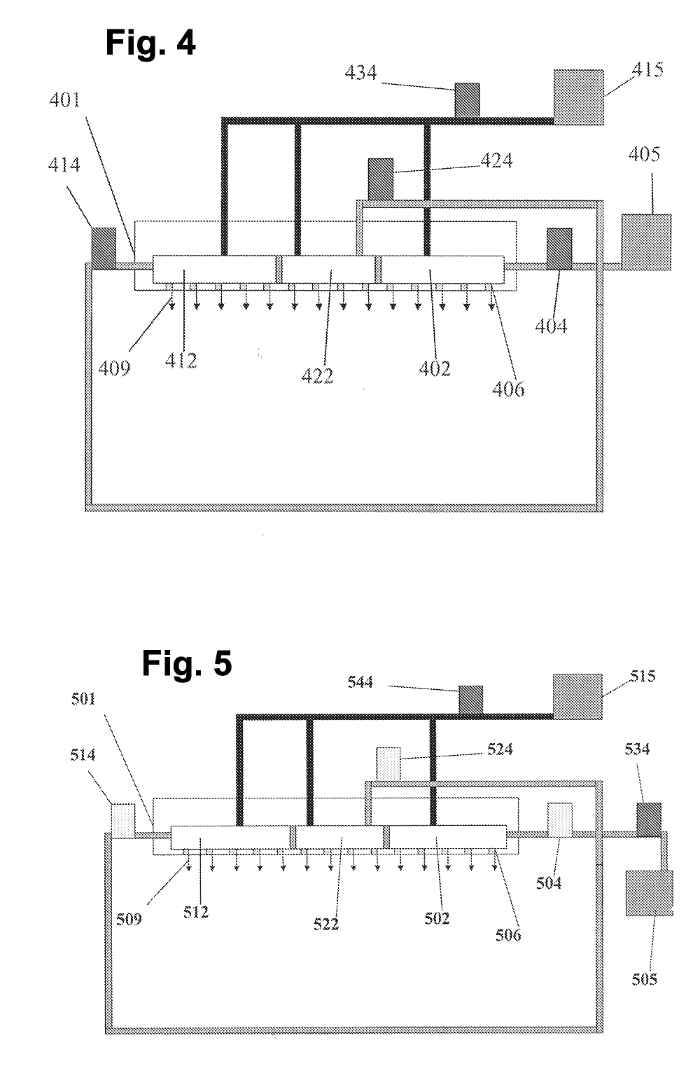

In another embodiment of this invention with showerhead shown in FIG. 4, the flows of the main reactant containing gases may be equally or proportionally (to the area of wafer corresponding) distributed by the showerhead 401 in a way that is not varied with each wafer. In this case only one mass flow gas controller 434 may be used for all the segments in the showerhead. The gas coming from source 415 The variations in etching rate distribution (or film properties) could then be accomplished by adding an etching suppressant and/or rate-decreasing gas (whose source is 405 to some or all segments of the showerhead 402,412,422. Such a suppressant could also be a chemically inert diluent. Flows of this gas would be controlled to each segment of the showerhead by a separate mass flow controller 404,414,424 which could be adjusted by the control system to provide the desired etching rate distribution. The gas then issues from holes 406 and is injected as streams 409 into the plasma.

Another method could have the added gas increase the rate (an accelerant). It would also be in accordance with this invention to have two sets of controllers to each segment one which controls enhancing gas flow while the other controls suppressant flows. Such flows would then be varied for each wafer to be processed in accordance with the desired etching rate distribution required. In one embodiment of this invention such a suppressant may be methane gas where the main etching gas mixture could be any of the following: sulfur hexafluoride and oxygen or a fluorocarbon (such as hexafluoroethane) and oxygen, or nitrogen trifluoride with or without oxygen. Another suppressant could be ammonia. A diluent could be helium or argon gases or nitrogen gas. For example, a decrease of 10% in the process rate might require from one to as much as fifty percent additional flow of such suppressant gas. More effective suppressors might produce the desired effect with lower flows. Such an effective suppressor might take only a few percent additional flow to produce a five percent or more reduction in rate. It is likely that this simple approach to control of the gas flows would require some adjustments in order to compensate for effects of suppressant flow to one segment causing decrease in etch rate in areas corresponding to nearby segments.

See FIG. 5 for a schematic of a showerhead from a reactor which again uses an accelerant or suppressant gas to achieve variation across the wafer in the etching or deposition rate. In this figure there is again only one set of flow controllers 544 feeding all showerhead segments in proportion to their areas with the main etching or deposition reactant or mixture of reactants from source 515. This source may be multiple pressurized containers of different gases, each having its own flow controller in set 544. However, in this case the suppressant or accelerant is also supplied to all segments by a single mass flow controller 534 with individually controllable shutoff valves 504,514,524 in the line to the reservoir 502,512,522 in each segment of the showerhead. In this case the shutoff valves with the suppressant 505 are turned on and off with a duty cycle appropriate to the degree of etching suppression desired for the area corresponding to each segment of the showerhead 501. Such flows to different sections may be phased so as to require more constant flow from the source 505. This flow controller may very likely need to change its flow during an etching step to reflect the change in the total flow of accelerant or suppressant gas needed for all segments at any point in time. The gas mixture which is injected into the plasma 509 from the holes in the showerhead 506 then varies with time for most or all segments producing an etching rate which varies in time but whose average on each segment produces the desired total etching rate profile on the wafer.

Another such control system could utilize a neural net method for determining the proper flow(s) to each segment (flows of reactant and suppressant or accelerant gases) basing the values on the desired distribution of the etching rate. Yet another control system could use a simple look up table with effects on the various regions tabulated for changed gas flow or composition in each segment. A weighted sum or average of such effects might then be the approximate result of such combined flow changes to the different segments.

One possible arrangement of the segments of the gas reservoir behind the showerhead is shown in FIG. 3a with several segments covering the range of radius from the center of the showerhead to the edge. There are also several segments covering the range of angular positions at any fixed radius. The range of possible distributions of etching or deposition process rates achievable with this showerhead reservoir is large. One possible limitation of etching or deposition rate distributions using this arrangement of segments may be that the rate cannot vary significantly across distances radially or angularly small compared with the sizes of the segments. For example, if the radial width of the segments in 5a is 4 cm then the rate may not be capable of being varied significantly through a local maximum and minimum with spacing of less than 4 cm. One can express this more formally by use of the Fourier series. If, for example, one uses 4 segments to cover the range of radius from center to edge at any angular position then it would be difficult to have an etching rate which has a significant Fourier component with more than 2 full wavelengths spanning the radius from center-to-edge. This is because oscillations in the process rate with wavelength less than two radial segments may be hard to achieve. Process rates which vary monotonically from center to edge will be easily achieved if they are close to linear in the radius and do not change by too large a factor. The pattern on the showerhead in FIG. 3b is very different, being suited best to etching rate variation across the wafer from one side to another.

In one embodiment of the invention the pattern of segments may not the same on one side of the showerhead as the other—be asymmetrical. Additionally, there may be more than one etching or deposition processing station each of which may have a different pattern of segments in its showerhead. If there were just one etching station its segments on one side may be arranged differently from those on the other or have different sizes. By employing such a non-symmetrical segment structure or more than one processing station with different gas injection segment patterns a greater range of non-uniformities may be etched away or deposited. This would be done by processing the wafer in two or more steps where the wafer may be moved from one station to another and may be rotated between steps. In one scheme the wafer is moved from one station to another between steps and its desired orientation computed separately for each step. Or in the case of a single asymmetrical etching station where the orientation of the wafer for each step is determined separately by the control system and the wafer may be processed in several separate steps on the same station. Both multiple passes through any etching or deposition station and use of multiple stations are embodiments of this invention. Wafer or substrate thickness or film thickness may be measured between any pair of steps to assure process performance or correct deviations from expected process results. This permits us to learn from the processing of each wafer, if desired, so as to have better predictive capability in the control system and more efficient processing of wafers or substrates.

In some semiconductor processing systems using capacitively coupled discharges etching rate distribution non-uniformities of less than ±2 percent cannot routinely or repeatably be achieved because conditions within the reactor chamber are not constant. Electrodes may not be adjusted (or remain) with perfect parallelism. Electrode surfaces warp, pit, and discolor unevenly, affecting the uniformity of the discharge and thus the uniformity of the etch. This invention may be able to alter the etch rate over multiple locations of the electrode in a manner that can be changed easily either periodically or from wafer to wafer or during the etch, to compensate for continuing variations in the reactor. This altered rate distribution can compensate for the preexisting non-uniformity of the wafer or to achieve any desired process result.

These and other objectives may be achieved in one embodiment of this invention by providing a means of measuring wafer or film thickness either before, during, and/or after the etching or deposition process, for the purpose of determining how the distribution of the process rate should be altered. Such measurements may be done by any number of commercially available film or wafer thickness monitoring systems. The thickness measurements which may be made within the system also may be made after the etch or deposition is complete, or at some period before the completion of the process may be used to determine the accuracy of the intended etch. The data collected may then be used to finely tune the uniformity control of the remainder of the etch to produce an optimum result on that wafer or to fine tune the uniformity control of the next wafers to be processed.

In case a deposition process is the objective the deposition rate distribution across a wafer may be altered by reducing in varying degrees the flows of gas(es) containing a depositing species to some subset of the segments, and/or increasing the flows of same gases (for example, such as silane gas which contains silicon which is used to form films of silicon dioxide) to some other subset of shower head segments. Such combination of segments to receive varying greater amounts of such gas and those to receive varied lesser amounts of gas would be determined by an algorithm performed by the control system, based on the desired pattern of deposition rate across the wafer.

When gas flows are adjusted (with an appropriately chosen segmentation of the showerhead) frequently to compensate for the reactor variations in an etching application, very high uniformities of etching rate—better than ±0.5 percent may be able to be achieved.

The invention has substantial advantages in controlling the uniformity of etching or deposition across a wafer in uniquely small increments. When used with thickness measurement techniques and methods currently available, the invention provides the ability to adjust etch rates across a wafer that can compensate for many factors, and to quickly adjust for changes in reactor parameters that affect the overall etch uniformity.

Another important feature and advantage of the invention is that it can be implemented with general types of hardware—that is capacitively coupled rf discharges between parallel plate electrodes—with which there is substantial experience in the semiconductor industry. It may also be employed with a narrow gap inductive discharge such as a so-called TCP reactor which is a small gap inductive discharge. This means that such processing can be rapidly commercialized in such manner that it is efficient and reliable.

It is apparent from the foregoing that a new and improved apparatus and method for controlling the etch rate or deposition distribution across a substrate have been provided. While only certain presently preferred embodiments have been described in detail, as will be apparent to those familiar with the art, certain changes and modifications can be made without departing from the scope of the invention as defined by the following claims.

1. A semiconductor wafer treatment process, comprising the steps of: introducing a gas into a reaction chamber through a segmented shower head, independently controlling the flow of processing gas through different segments of the shower head to adjust processing rates in different areas of a wafer which correspond to the different segments, monitoring a parameter in each of the different areas, and adjusting the flow of gas through the segments in accordance with the monitored parameter.

2. The process of claim 1 wherein the parameter is monitored during the processing of the wafer to determine the effectiveness of the current flow rates in the processing, and the flow of gas through the segments is adjusted in accordance with the monitored parameter while the wafer is being processed to control the processing rates in the different areas of the wafer.

3. The process of claim 1 wherein the parameter is monitored after the processing of the wafer is complete to determine the effectiveness of the flow rates in the processing, and the flow rates to the different areas are adjusted in accordance with the monitored parameter for use on a subsequent wafer.

4. The process of claim 1 where the thickness of the wafer in the different areas is measured, and the flow of gas through the segments is adjusted in accordance with the measured thickness to produce a wafer of predetermined thickness and uniformity.

5. The process of claim 1 wherein the introduction of the processing gas causes a film to be deposited on the wafer, the flow of gas through the different segments of the shower head is controlled to adjust etch rates in the corresponding areas of the wafer, the thickness and uniformity of the film in the different areas are measured, and the flow of gas through the segments is adjusted in accordance with the measurements to control the deposition rates in the different areas.

6. The process of claim 5 wherein the flow of gas through the segments is adjusted to produce a wafer of predetermined thickness and uniformity.

7. The process of claim 5 including the step of increasing the flow of the etchant to at least one of the segments to provide an increased etch rate in the corresponding area(s) of the wafer.

8. The process of claim 5 including the step of adding a diluent or etch suppressant gas to the processing gas delivered to at least one of the segments to decrease the etch rate in the corresponding area(s) of the wafer.

9. The process of claim 5 including the steps of adding a diluent or etch suppressant to the processing gas, and decreasing the flow of etchant gas through at least one of the segments to provide a decreased etch rate in the corresponding area(s) of the wafer.

10. The process of claim 5 including the step of interrupting the gas flow through at least one of the segments to provide a decreased etch rate in the corresponding area(s) of the wafer.

11. The process of claim 1 wherein the introduction of the processing gas causes a film to be deposited on the wafer, the flow of gas through the different segments of the shower head is controlled to adjust film deposition rates in the corresponding areas of the wafer, the thickness and uniformity of the film in the different areas are measured, and the flow of gas through the segments is adjusted in accordance with the measurements to control the deposition rates in the different areas.

12. The process of claim 11 wherein the flow of gas through the segments is adjusted to compensate for non-uniformities in the film deposited on the wafer.

13. The process of claim 11 including the step of decreasing the gas flow through at least one of the segments to decrease the deposition rate in the corresponding area(s) of the wafer.

14. The process of claim 11 including the step of adding a diluent to the gas in at least one of the segments to decrease the deposition rate in the corresponding area(s) of the wafer.

15. The process of claim 11 including the steps of adding a diluent to the gas and decreasing the flow gas in at least one of the segments to decrease the deposition rate in the corresponding area(s) of the wafer.

16. The process of claim 11 including the step of interrupting the gas flow through at least one of the segments to provide a decreased deposition rate in the corresponding area(s) of the wafer.

17. A process of treating a substrate in a reactor with a showerhead electrode having a plurality of interior compartments which can be individually supplied with gas and are substantially isolated from each other and are distributed within the electrode to cover a total area corresponding to and roughly covering that of the substrate, with each of interior compartments communicating with a discharge volume outside the electrode through a plurality of small holes, comprising the steps of: individually supplying every compartment within the electrode with processing gas such that each compartment receives a fixed proportion of the processing gas relative to the other compartments, supplying controllable amounts of gas other than the processing gas to a portion of the compartments to alter the processing rate in areas of the substrate corresponding to the compartments receiving the other gas, and energizing the electrode with RF energy to ionize the gas and produce a plasma of active species for treating the substrate.

18. The process of claim 17 where the maximum permitted flow of the other gas to any compartment is less than about 20% of the flow of the processing gas to that compartment.

19. The process of claim 17 wherein the total flow of the other gas to all compartments is less than or about 20% of the total flow of the processing gas to all compartments.

20. The process of claim 17 wherein the flow of the other gas to any compartment is less than or about 10% of the total flow of the processing gas to that compartment.

21. The process of claim 17 wherein the processing gas is an etchant.

22. The process of claim 21 wherein the other gas is a diluent or an etch suppressant.

23. The process of claim 17 wherein the processing gas is a gas for depositing a film on the substrate.

24. The process of claim 23 wherein the other gas is a diluent or a deposition suppressant.
